(19) United States
(12) Patent Application Publication
(10) Pub. No.: US 2018/0018161 A1
(43) Pub. Date: Jan. 18, 2018

(54) UPDATING FIRMWARE AT ENTERPRISE DEVICES

(71) Applicant: BlackBerry Limited, Waterloo (CA)

(72) Inventors: Balasubrahmanyam GATTU, San Ramon, CA (US); Robert Lorne BOWERMAN, Waterloo (CA); Paul Douglas MORLEY, Corinth, TX (US); Jeffrey Alan KUCKELMAN, Horseheads, NY (US)

(73) Assignee: BlackBerry Limited, Waterloo (CA)

(21) Appl. No.: 15/208,929

(22) Filed: Jul. 13, 2016

(51) Int. Cl. G06F 9/445

(52) U.S. Cl. CPC G06F 8/67; G06F 9/44505

(57) ABSTRACT

An enterprise server selectively controls the ability of enterprise devices to install firmware updates. In some examples, the enterprise server identifies a subset of enterprise devices designated as alpha devices for testing functionality of newly installed firmware updates prior to installation at the remaining non-alpha devices, the alpha devices being configured to apply a first firmware update policy that enables installation of firmware updates. The enterprise server transmits a first command to the non-alpha devices to apply a second firmware update policy that disables or postpones installation of firmware updates. Once a new firmware version is determined to be installed at a number of alpha devices of a particular type for a period time, without problems, the enterprise server transmits a second command to the non-alpha devices of the particular type to temporarily apply the first firmware update policy, thereby enabling installation of the new firmware version.

### BACKGROUND

Firmware refers to computer-executable code used to control the hardware of an electronic device in operation. Firmware is typically stored in the non-volatile memory of the electronic device by the original equipment manufacturer (OEM) at the time of manufacturing.

From time to time, a new firmware version or operating system (OS) version may be developed by an OEM for a particular model of electronic device, for example, to fix defects identified by consumers or operators, or to provide additional functionality or performance to the electronic device.

Electronic devices that are associated with an enterprise system may be referred to as enterprise devices. An enterprise server may be used to manage enterprise devices and to control their ability to access services within the enterprise system.

### BRIEF DESCRIPTION OF THE DRAWINGS

FIG. 1 illustrates a schematic diagram showing an environment for firmware update installation in enterprise devices according to some examples of the proposed technology.

FIG. 2 illustrates a method for controlling a firmware update policy at enterprise devices according to some examples of the proposed technology.

FIG. 3 illustrates a method for installing a firmware update at enterprise devices according to some examples of the proposed technology.

### DETAILED DESCRIPTION

While the intention of updating firmware in electronic devices may be to fix defects or bugs, to add functionality, and/or to improve performance, sometimes installation of a firmware update may result in unintended problems. That is, following installation of a new firmware version at a particular electronic device, there may be a negative impact on device functionality as a direct or indirect result of the installation. For example, one or more applications on the device may crash or not operate as expected.

Problems associated with firmware update installation may only become apparent once the new firmware version has been tested for a sufficient amount of time at the electronic devices at which the new firmware version has been installed.

In the case of consumer applications and functionalities, OEMs and operators may perform a variety of tests to identify any bugs or issues arising from installation of a new firmware or OS version. Where issues are identified, the operators may obtain fixes from OEMs.

In the case of applications and services deployed by an enterprise, the tests performed by OEMs and operators may or may not identify bugs or issues arising from installation of a new firmware version. For example, an enterprise may enable security or data protection features that are not tested during the normal testing of consumer applications and functionalities that is performed by OEMs and operators. Accordingly, it may be of interest to perform additional testing of enterprise-deployed applications and services in order to identify problems that may be otherwise missed.

Generally, enterprises do not receive a pre-release of a firmware/OS update before the update is made available to all enterprise devices. The inventors have recognized that there may be advantages to providing time for testing of enterprise-deployed applications and services with a firmware update on a limited number of enterprise devices, before that update is applied to a wider pool of enterprise devices. For example, there may be advantages to enabling installation of firmware updates on some electronic devices, while temporarily disabling, blocking or postponing installation of firmware updates on other electronic devices. Some electronic device users may be more suited to testing functionality of an electronic device following installation of a firmware update and identifying/reporting problems associated with the installation so that the problems can be resolved. Other electronic device users may prefer to reduce the likelihood of experiencing problems associated with firmware update installation, and may consider it acceptable to postpone the installation until such time as the problems have been resolved. The inventors have also recognized that, in the case of a large number of electronic devices to be updated with a new firmware version, rather than enabling installation of the new firmware version at all electronic devices at once, it may be more efficient and cost-effective to enable the installation at a subset of the devices, such that the new firmware version may be tested (and problems, if any, may be identified and resolved), and then proceed to enable installation of the new firmware version at the remaining devices, provided that no problems have been identified or that any identified problems are resolved prior to installation at the remaining devices. For electronic devices that are associated with an enterprise, an enterprise server may be used to control installation of firmware updates in these and other manners, in accordance with the technology proposed herein.

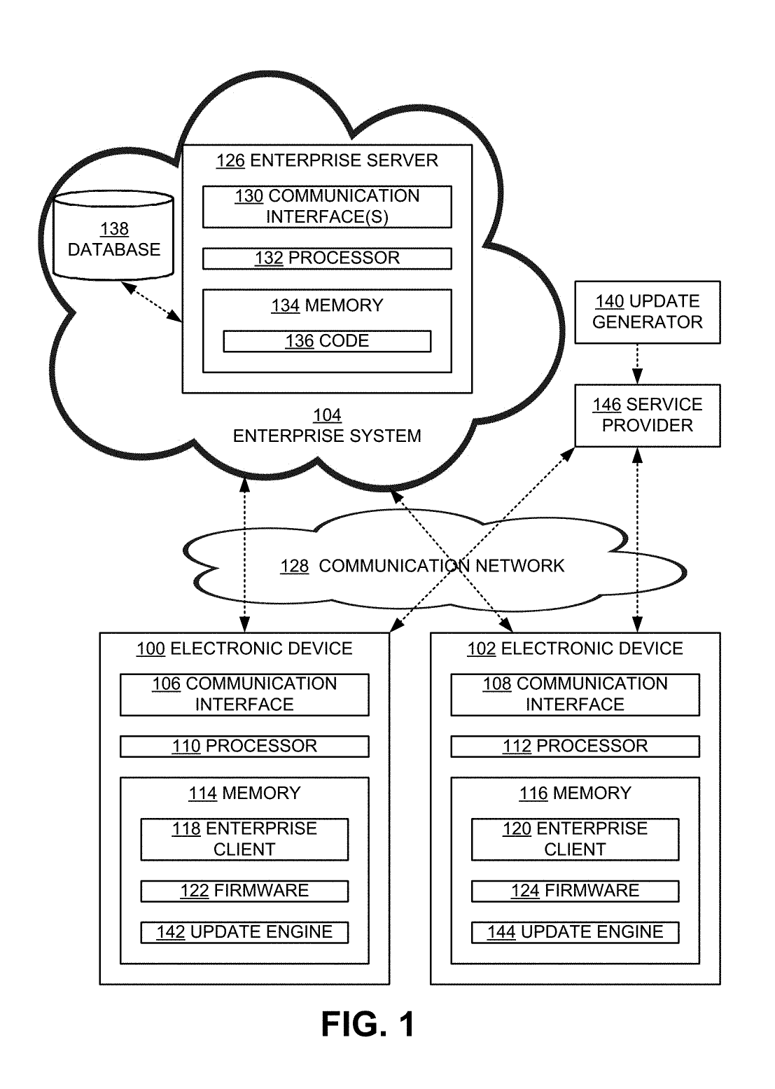

FIG. 1 illustrates a schematic diagram showing an environment for firmware update installation at enterprise devices according to some examples of the proposed technology.

Electronic devices 100, 102 are examples of electronic devices associated with an enterprise system 104, and therefore may also be referred to as enterprise devices 100, 102. As used herein, the term “enterprise” may refer to a business or work relationship, but may also refer to other types of networking environments in which centralized resources are managed collectively.

Examples of the enterprise devices 100, 102 include mobile electronic devices, cellular phones, tablets, personal digital assistants (PDAs), laptops, and the like.

Each of the enterprise devices 100, 102 comprises a respective communication interface 106, 108, a respective processor 110, 112, and a respective computer-readable memory 114, 116. Within the respective memories 114, 116 there is stored respective enterprise clients 118, 120. The enterprise clients 118, 120 enable the enterprise devices 100, 102 to access enterprise services that are associated with the enterprise system 104. Examples of enterprise services include e-mail, enterprise contacts, calendars, notes, instant messaging, business applications for travel, human resources, shared documents repositories, source code access and updating, access to enterprise internal websites, and the like.

Within the respective memories memory 114, 116 of the enterprise devices 100, 102 there is also stored respective firmware 122, 124 for controlling operation of the enterprise devices 100, 102. The nature of the firmware installed at each enterprise device may depend on the particular manufacturer of the device and the particular model of the device. For example, a Samsung Galaxy® S7™ is associated with different firmware than a BlackBerry Curve® 8520™. Furthermore, for a given type of device (e.g., manufacturer and model number), there may exist more than one version of firmware. Thus, the firmware that is installed at each enterprise device may be associated with a type of device and a version number.

The enterprise devices 100, 102 are able to communicate, via their respective communication interfaces 106, 108, with an enterprise server 126 within the enterprise system 104. Communication may occur over a communication network 128, which may comprise one or more wireless networks, one or more wired networks, or a combination thereof. Examples of the communication network 128 include a wireless carrier network, the Internet, a wireless wide area network (WWAN), a WIFI® network, a physical connection such as a Universal Serial Bus (USB) cable, and the like. Each communication interface 106, 108 is compatible with the communication network 128. Although not explicitly illustrated, the enterprise devices 100, 102 may comprise additional communication interfaces, including, for example, short-range wireless communication interfaces such as a wireless personal area network interface, possibly compatible with Bluetooth®.

The enterprise server 126 comprises communication interface(s) 130, a processor 132 and a computer-readable memory 134. The communication interface(s) 130 may be configured for communication with the enterprise devices 100, 102 over the communication network 128 and also for communication with other electronic devices within the enterprise system 104. Within the memory 134, there is stored computer-executable instructions or code 136 which, when executed by the processor 132, causes the enterprise server 126 to perform actions in accordance with technology that will be described in more detail below.

The enterprise system 104 may also comprise a database 138 that is accessible to the enterprise server 126 via the communication interface(s) 130. The database 138 may store information associated with all enterprise devices that are associated with the enterprise system 104, including the enterprise devices 100, 102. The stored information may include device identifiers, user identifiers, device types (including, for example, manufacturer and model number), enterprise applications installed at the devices, information about the firmware currently installed at the devices (including version numbers), enterprise policies applied at the devices, device status with respect to the applied enterprise policies (e.g., compliant or non-compliant), and the like.

From time to time, a new version of firmware (also referred to as a firmware update) may become available for installation at a particular type of electronic device, for example, to fix defects identified by consumers or operators, or to provide additional functionality or performance to the electronic device. Firmware Over-the-Air (FOTA) updating is widely used for updating firmware in wirelessly connected electronic devices, such as mobile devices that subscribe to wireless communications services provided by mobile operators. FOTA updating typically requires an update generator, a communications protocol, and an update engine. The update generator creates an update file, often referred to as a delta file or delta package, which comprises the differences between the new, updated firmware version and the existing firmware version. The communications protocol is used to send the delta package to the electronic devices to be updated with new firmware. A common communications protocol used in FOTA updating is the Open Mobile Alliance Device Management (OMA DM) standard. The update engine resides on the electronic devices themselves, and performs updating (including installation) of the firmware update received in the form of the delta package. In some examples, rather than providing an update in the form of a delta package, an update may comprise the entire firmware/OS image. It is also possible that a proprietary protocol mechanism may be used to deliver an update patch or image to a device.

Referring again to FIG. 1, there is illustrated an example update generator 140 and example update engines 142, 144 residing in the memories 114, 116 of the enterprise devices 100, 102, respectively. A delta package generated at the update generator 140 may be sent to the enterprise devices 100, 102 through a service provider 146 (typically either the OEM that manufactured the enterprise devices 100, 102 or the mobile operator providing wireless communications services to the enterprise devices 100, 102). The service provider 146 may be configured to communicate with the enterprise devices 100, 102 in order to push the delta package Over-the-Air (OTA) to the enterprise devices 100, 102, for installation by the update engines 142, 144, respectively. In the example of FIG. 1, the communication between the service provider 146 and the enterprise devices 100, 102 is illustrated as occurring over the communication network 128, but this communication may occur over another suitable wireless communication network.

The process of updating firmware at an electronic device is generally performed according to one of two modes: “push mode” and “pull mode”. According to pull mode, the process is initiated locally at the electronic device. Either periodically or in response to manual initiation by a user of the electronic device, the electronic device may query a firmware repository for a newer firmware version than the version that is currently installed at the electronic device. Once a newer version is available, the update engine may automatically download the delta package and install the firmware update. According to push mode, the update engine may be activated when the device receives the push notifications informing of available firmware updates. A push notification may be sent by a push server and may prompt for acceptance of a particular firmware update. The push notification may be sent in response to an update command originating, for example, from the OEM or the operator. In response to acceptance of the particular firmware update indicated in the push notification, the update engine may download the delta package and install the firmware update.

As previously noted, the inventors have recognized that there may be advantages to enabling installation of firmware updates on some electronic devices, while disabling, blocking or postponing the installation of firmware updates on other electronic devices.

In accordance with some examples of the proposed technology, within a plurality of electronic devices managed by an enterprise server, those electronic devices that are perpetually or continuously enabled for installation of firmware updates may be herein referred to as “alpha devices”. Alpha devices are generally able to download and install firmware updates as they become available. Enterprise devices that are not identified as alpha devices may herein be referred to as “non-alpha devices”. As will be described in more detail below, non-alpha devices may generally be disabled from installation of firmware updates, and may only be temporarily enabled for installation of firmware updates under certain circumstances. For example, non-alpha devices may be temporarily enabled for installation of firmware updates after a particular firmware update has been installed on one or more alpha devices for a threshold amount of time and no problems have been detected in association with the installation. Alpha devices may be regular enterprise devices with enterprise applications and services just like non-alpha devices, but with users who are willing to install new firmware/OS updates as soon as they become available and willing to report any issues associated with the installation. Alpha devices may be considered as “test devices” in that they may be configured to accept the firmware updates prior to installation of those firmware updates at non-alpha devices.

A given electronic device may be identified as an alpha device (or a non-alpha device) in a variety of different ways. For example, an enterprise user who is associated with one or more enterprise devices may volunteer to designate at least one of those devices as an alpha device. In one example, the enterprise user may send an e-mail to an enterprise administrator identifying him/herself as an alpha user and/or selectively indicating one or more of his/her enterprise devices to be associated with an alpha designation. Alternatively, an enterprise user may identify him/herself as a non-alpha user and/or selectively indicate one or more of his/her enterprise devices to be associated with a non-alpha designation. In another example, when a new device is activated with an enterprise server, it may, by default, be considered as a non-alpha device, unless the new device has already been identified as an alpha device. In another example, alpha users may use a special version of an enterprise application for activation of their devices with the enterprise server, allowing the enterprise server to mark the devices as alpha devices. In another example, the enterprise may use one enterprise server for alpha users and devices, and another, different enterprise server for non-alpha users and devices. In this example, all devices activated with the alpha enterprise server may be marked as alpha devices. In another example, an enterprise user may use an activation link to identify him/herself as an alpha user (or a non-alpha user) and/or to selectively identify one or more of his/her enterprise devices as alpha devices (or non-alpha devices). In the case that a particular enterprise user is identified as an alpha user, all enterprise devices activated by that particular user within the enterprise may be treated as alpha devices. Alternatively, in the case that only a subset of the enterprise devices associated with the particular enterprise user are identified as alpha devices, only those devices within the subset may be treated as alpha devices, while the remaining devices may be treated as non-alpha devices.

The enterprise server may track which enterprise devices are identified as alpha devices and which enterprise devices are identified as non-alpha devices using information stored in a database accessible to the enterprise server. An alpha designation may comprise, for example, a flag in the memory or a specific database file being marked with a specific value or some other identifier. The alpha designation may be stored in association with a unique device identifier, such as an International Mobile Equipment Identity (IMEI) or a Mobile Equipment Identifier (MEID) or an Electronic Serial Number (ESN) or any other identifier which can uniquely identify the enterprise device, thereby identifying the enterprise device as an alpha device. Alternatively, a non-alpha designation may be stored in association with a unique device identifier associated with a particular enterprise device, thereby identifying the enterprise device as a non-alpha device. According to some examples, the absence of a designation may itself be indicative of whether or not an enterprise device is identified as an alpha device or a non-alpha device. For example, alpha devices may be identified by an alpha designation, while non-alpha devices may be identified by the absence of an alpha designation. Alternatively, non-alpha devices may be identified by a non-alpha designation, while alpha devices may be identified by the absence of a non-alpha designation.

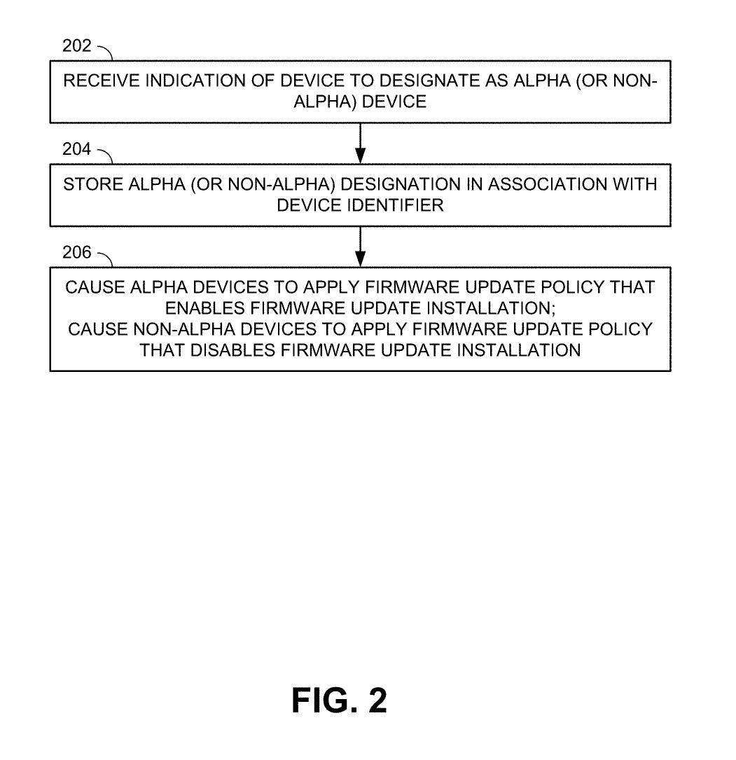

FIG. 2 illustrates a method for controlling a firmware update policy at enterprise devices according to some examples of the proposed technology.

At 202, an enterprise server may receive an indication of an enterprise device to be designated as an alpha device or as a non-alpha device. For example, with reference to FIG. 1, the enterprise server 126 may receive an indication that the enterprise device 100 is to be designated as an alpha device. Alternatively, the enterprise server 126 may receive an indication that the enterprise device 102 is to be designated as a non-alpha device. The indication may be received, for example, via an e-mail to an enterprise administrator, via an activation link, or via input provided by an enterprise administrator locally at the enterprise server, using an input device such as a keyboard. In some examples, when an electronic device is initially activated with an enterprise, the enterprise server may, by default, receive an indication that the electronic device is to be designated as a non-alpha device.

At 204 the enterprise server may store an alpha designation (or a non-alpha designation) in association with a unique device identifier of the enterprise device indicated at 202, thereby identifying that device as an alpha device (or a non-alpha device). The alpha (or non-alpha) designation may be stored together with the unique device identifier in a database accessible to the enterprise server. For example, referring again to FIG. 1, in the event that the enterprise server 126 receives an indication that the enterprise device 100 is to be designated as an alpha device, an alpha designation may be stored in association with a unique device identifier of the enterprise device 100 in the database 138. Alternatively, in the event that the enterprise server 126 receives an indication that the enterprise device 102 is to be designated as a non-alpha device, a non-alpha designation may be stored in association with a unique device identifier of the enterprise device 102 in the database 138.

The ability of a particular electronic device to install firmware updates may be controlled by a firmware update policy applied at the device. The manner in which the firmware update policy is specified may depend on the operating system or OEM of the particular device. For example, in the case of Samsung® devices, installation of firmware updates may be controlled using the application program interfaces (APIs) setDisableApplication and setEnableApplication. The setDisableApplication API may be used to silently disable the application responsible for installing firmware updates, while the setEnableApplication API may be used by to silently enable the application. For example, with reference to FIG. 1, using the setDisableApplication API on the enterprise device 102 may cause the update engine 144 to be disabled, thereby preventing installation of firmware updates received from the service provider 146. In another example, in the case of Android devices, installation of firmware updates may be controlled using a class called SystemUpdatePolicy. Depending on the settings specified for the SystemUpdatePolicy class, incoming firmware updates may be automatically installed as soon as they become available (or within a daily maintenance window) or the updates may be blocked for a specific period of time, up to a maximum of 30 days. Upon expiration of blocking period, the electronic device may revert back to its normal behaviour, as if no firmware update policy were set.

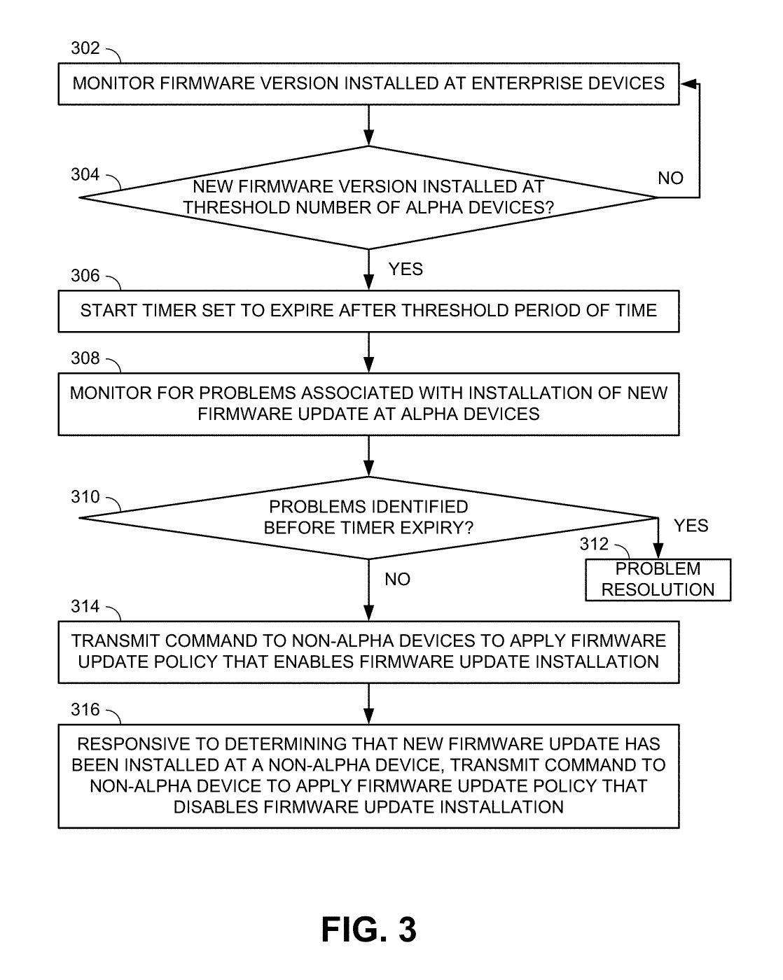

In accordance with some examples of the proposed technology, an enterprise server may cause one firmware update policy to be applied to enterprise devices that are identified as alpha devices, and may cause another, different firmware update policy to be applied to the remaining enterprise devices (i.e., enterprise devices that are identified as non-alpha devices). The firmware update policy applied to alpha devices may enable installation of firmware updates on those devices as the firmware updates become available. In contrast, the firmware update policy applied to the remaining non-alpha devices may disable installation of firmware updates on those devices. Under certain circumstances, the enterprise server may cause non-alpha devices to temporarily modify their local firmware update policy in order to enable installation of a particular firmware update. For example, if it is determined that a number of alpha devices have installed a new firmware update and that no problems associated with the installation have been detected for a threshold period of time, the enterprise server may cause the non-alpha devices to temporarily apply a firmware update policy that enables installation of firmware updates at the non-alpha devices. Once the non-alpha devices are determined to have installed the new firmware update, the enterprise server may then cause the non-alpha devices to revert back to a firmware update policy that disables installation of any future firmware updates. This will be described in more detail with respect to FIG. 3.

Returning to FIG. 2, once the enterprise server is able to identify whether a particular enterprise device has been designated as an alpha device or a non-alpha device, the enterprise server may cause the particular enterprise device to apply a firmware update policy in accordance with its alpha (or non-alpha) designation. For example, referring to FIG. 1, upon consulting the database 138, the enterprise server 126 may determine that an alpha designation is stored in association with a unique device identifier of the enterprise device 100, thereby identifying the enterprise device 100 as an alpha device. Alternatively or additionally, the enterprise server 126 may, upon consulting the database 138, determine that a non-alpha designation is stored in association with a unique device identifier of the enterprise device 102, thereby identifying the enterprise device 102 as a non-alpha device.

The enterprise server may cause the enterprise devices to apply different firmware update policies based on their identification as alpha and non-alpha devices, respectively. As shown at 206, the enterprise server may cause alpha devices to apply a firmware update policy that enables installation of firmware updates, and may also cause non-alpha devices to apply a firmware update policy that disables or postpones installation of firmware updates.

In some examples, the enterprise server may cause an enterprise device to apply a particular firmware update policy by sending a message or command to that device. Such a command may be handled by an enterprise client at the enterprise device, and may enforce the required policy on the enterprise device by using an API provided by the OEM of the enterprise device. For example, referring to FIG. 1, in the event that the enterprise device 100 is identified as an alpha device, the enterprise server 126 may transmit a message to the enterprise device 100 causing the enterprise device 100 to apply a firmware update policy that enables installation of firmware updates (i.e., enables the update engine 142 to install any firmware updates received from the service provider 146). Alternatively or additionally, in the event that the enterprise device 102 is identified as a non-alpha device, the enterprise server 126 may transmit a message to the enterprise device 102 causing the enterprise device 102 to apply a firmware update policy that disables or postpones installation of firmware updates (i.e., disables the update engine 144 from installing any firmware updates received from the service provider 146). In the case that the enterprise devices 100, 102 are Samsung® devices, the message sent to the enterprise device 100 at 206 may cause the enterprise device 100 to call the setEnableApplication API, whereas the message sent to the enterprise device 102 at 206 may cause the enterprise device 102 to call the setDisableApplication API. Alternatively, in the case that the enterprise devices 100, 102 are Android devices, the message sent to the enterprise device 100 at 206 may cause the enterprise device 100 to use SystemUpdatePolicy with a setting that enables automatic installation of firmware updates as they become available, whereas the message sent to the enterprise device 102 at 206 may cause the enterprise device 102 to use SystemUpdatePolicy with a setting that blocks installation of firmware updates for a specified period of time, up to a maximum of 30 days. In the case that the firmware update policy applied to non-alpha devices is only configurable to block installation of firmware updates for a limited period of time before returning to a default firmware update policy that enables firmware update installation, the enterprise server may periodically send messages to the non-alpha devices that cause them to re-apply the firmware update policy that blocks firmware update installation. These are just some examples of how firmware updates may be controlled. There may other methods for controlling firmware updates on Samsung devices or other OEM devices using the APIs provided by the OEMs or OS platform.

In other examples, the enterprise server may effectively cause an enterprise device to apply a particular firmware update policy by refraining from sending a firmware update policy command to that device. For example, typically, when electronic devices are initially purchased from OEMs or operators by consumers or enterprises, the electronic devices, by default, already apply a firmware update policy that enables installation of firmware updates. That is, the electronic devices already behave as alpha devices. When one of these electronic devices is newly activated with an enterprise, and when the indication received at 202 is that the device is to be designated as an alpha device, it may be unnecessary for the enterprise server to send a firmware update policy command to that device, since the device is already applying the appropriate firmware update policy by default. Thus, by refraining from sending a firmware update policy command to the device, the enterprise server is effectively causing the device to apply the firmware update policy that enables firmware update installation at 206, in accordance with the indication received at 202.

As previously discussed, an enterprise server may track or monitor information about the enterprise devices associated therewith, including version information about firmware that is currently installed at each enterprise device. For example, referring to FIG. 1, the enterprise server 126 is aware of the version of the firmware 122 that is currently installed at the enterprise device 100, as well as the version of the firmware 124 that is currently installed at the enterprise device 102. The version information may be stored, for example, in the database 138.

From time to time, a new firmware version may be created for installation on enterprise devices, such as the enterprise devices 100, 102. In the following example, it may be assumed that the enterprise devices 100, 102 are of the same type (i.e., have the same manufacturer and model number) and therefore that they are expected to use the same firmware. It may also be assumed that the enterprise device 100 has been identified as an alpha device, while the enterprise device 102 has been identified as a non-alpha device, for example, according to the method of FIG. 2. As a result of being identified as an alpha device, the enterprise device 100 may be continuously enabled for installation of firmware updates, as previously described. Accordingly, when a new version of firmware is created for this type of device, the enterprise device 100 may automatically download and install the new version, for example, using FOTA updating. On the other hand, as a result of being identified as a non-alpha device, the enterprise device 102 may temporarily be disabled from installing firmware updates, as previously described. Accordingly, the new version of firmware that was automatically downloaded and installed at the alpha enterprise device 100, may be blocked, at least temporarily, from being installed at the non-alpha enterprise device 102.

During the period that the new firmware version is blocked from being installed at the non-alpha enterprise device 102, the new firmware version may be tested at the alpha enterprise device 100. During the testing, any problems associated with the installation of the new firmware version at the alpha enterprise device 100 may be detected and resolved. For example, in the event that the new firmware version causes a particular enterprise application or service to malfunction at the alpha enterprise device 100, a new version of the particular application may be created that functions correctly with the new firmware version (i.e., that fixes the bugs that caused the application to malfunction). Enterprise devices, such as the devices 100, 102, may be updated with the new version of the application by downloading it from an OEM/OS vendor-provided app store, such as Google Play® or Apple® App Store®, or by directly downloading the new version of the application from the enterprise server 126 and performing the update using an API provided by the OEM. By temporarily blocking installation of the new firmware version at the non-alpha enterprise device 102, it may be possible to prevent the non-alpha enterprise device 102 from experiencing the problems detected at the alpha enterprise device 100 in association with the installation. That is, the non-alpha enterprise device 102 may be updated with the new version of the particular application prior to installation of the new firmware version, thereby avoiding the malfunction that occurred at the alpha enterprise device 100. This may be advantageous, for example, if the user of the non-alpha enterprise device 102 wishes to reduce the likelihood of experiencing problems associated with installation of firmware updates, and prefers that those problems be detected and reported by other users. For example, the user of the alpha enterprise device 100 may be more suited to testing device functionality following installation of firmware updates and identifying/reporting problems associated with the installation than the user of the non-alpha enterprise device 102.

In the case of a large number of enterprise devices, there may be additional advantages to designating a subset of the devices as alpha devices, and the remaining devices as non-alpha devices. For example, it may be advantageous from an efficiency standpoint to identify a problem associated with a firmware update by installing the firmware update at a relatively small number of alpha devices, so that the problem may be resolved prior to installing the firmware update at the relatively large number of remaining non-alpha devices.

FIG. 3 illustrates a method for installing a firmware update at enterprise devices according to some examples of the proposed technology.

As previously discussed, an enterprise server may monitor which version of firmware is currently installed at each enterprise device, as shown at 302. For example, referring to FIG. 1, the enterprise server 126 may periodically consult the database 138 to determine the type and version of the firmware 122, 124 installed at the enterprise devices 100, 102.

As discussed with respect to FIG. 2, the alpha devices managed by the enterprise server are configured to apply a firmware update policy that enables installation of firmware updates. Thus, in the event that a new firmware version becomes available for a particular type of enterprise device, any alpha devices of that particular type may install the new firmware version. Installation of the new firmware version may not occur simultaneously at all alpha devices. That is, the new firmware version may be installed at a slightly different time at each device. When the new firmware version is installed at a particular enterprise device, an enterprise database, such as the database 138, may be updated with information about the new firmware version, including the version number.

While monitoring the firmware version currently installed at each enterprise device, as shown at 302, the enterprise server may check at 304 whether a new firmware version has been installed at a threshold number of alpha devices of a particular type (e.g., manufacturer and model number). The threshold number may be less than or equal to the total number of alpha devices of that particular type.

As long as it is determined at 304 that a new firmware version has not been installed at the threshold number of alpha devices of the particular type, the enterprise server may take no action and may continue to monitor the firmware versions currently installed at the enterprise devices.

In the event that the enterprise server determines at 304 that a new firmware version has been installed on at least the threshold number of alpha devices of the particular type, the enterprise server may initiate a process for enabling installation of the new firmware version at the remaining non-alpha devices of the particular type.

This process may begin at 306 by starting a timer that is set to expire after some threshold period of time. The threshold period of time may be specified at the enterprise system, for example, by an administrator. Examples of possible threshold time periods include three days, seven days, ten days and the like.

At 308, the enterprise server may begin monitoring for problems associated with installation of the new firmware version at the alpha devices of the particular type. Although the monitoring is illustrated as beginning after the start of the timer, it is contemplated that the monitoring may begin earlier than this. For example, the enterprise server may monitor for problems associated with installation of a new firmware version as soon as the enterprise server becomes aware that a new firmware version has been installed at any alpha device of a particular type.

Problems associated with the installation of the new firmware version at the alpha devices may be identified in a variety of ways. For example, a user of an alpha device may send an e-mail to enterprise administrator to report issues, such as not being able to use enterprise-supported services or data at the alpha device following installation of the firmware update. In another example, an enterprise administrator may notice abnormalities within the enterprise system, such as service interruptions, following installation of the firmware update. In another example, the enterprise administrator may become aware that an enterprise-developed application is repeatedly crashing or not working as expected on enterprise devices that have been updated with new firmware.

At 310, the enterprise server may check whether any problems associated with the installation of the new firmware version at the alpha devices have been identified prior to expiry of the timer.

In the event that problems associated with the installation of the new firmware version have been identified at 310, resolution of the identified problems may be initiated at 312. Problem resolution may involve informing the OEM of the problems so that they may be rectified in a subsequent firmware version. Alternatively or additionally, problem resolution may involve fixing bugs in enterprise applications and delivering the updated applications to enterprise devices or making enhancements or fixes to enterprise services to adopt the changes in the new firmware version installed on the alpha devices.

Importantly, in the event that problems are identified at 310, the non-alpha devices, which continue to apply a firmware update policy that disables installation of firmware updates, will be prevented from installing the new firmware version that is associated with the problems. Accordingly, the non-alpha devices may be prevented from experiencing the problems that are experienced by the alpha devices. Although not explicitly illustrated in FIG. 3, it is contemplated that, once the problem resolution at 312 is complete (including, for example, updating all enterprise devices with new versions of enterprise applications/services, as needed to address any problems identified at 310), the non-alpha devices may be enabled for installation of a firmware update (see 314, described below).

In the event that no problems associated with the installation of the new firmware version have been identified by the expiry of the timer (or that all identified problems have been resolved during the problem resolution at 312), the enterprise server may proceed at 314 to transmit a message or a command to the non-alpha devices of the particular type that causes those devices to apply a firmware update policy that enables installation of firmware updates. Accordingly, the non-alpha devices will be able to install the new firmware version. Given the lack of any identified problems at 310 (or the resolution of any identified problems at 312), it may be expected that the non-alpha devices will not experience any problems with the installation.

Unlike the alpha devices, which are continuously enabled for installation of firmware updates, the non-alpha devices may generally be disabled from installing firmware updates. The non-alpha devices may only be temporarily enabled for installing firmware updates when a particular firmware update has been successfully tested by the alpha devices and is deemed safe to install (that is, installation of the particular firmware update is not expected to cause problems). After installation of the particular firmware update, the non-alpha device may revert back to applying a firmware update policy that disables installation of firmware updates, as shown at 316.

Similarly to the alpha devices, installation of the new firmware version may not occur simultaneously at all non-alpha devices. Accordingly, the enterprise server may monitor the firmware version currently installed at each non-alpha device, and, for a given non-alpha device, the enterprise server may only transmit a command to apply a firmware update policy that disables firmware update installation after it has been determined that the new firmware version has been installed at that device, as shown at 316. In this manner, the non-alpha devices, which were temporarily enabled for installation of firmware updates as a result of the command sent at 314, will install the most recent firmware update, and will then be disabled from installing future firmware updates until such time as the method illustrated in FIG. 3 may be repeated.

The technology described herein permits selective control by an enterprise server of firmware update installation at enterprise devices, which may enhance user experience, and may provide for more efficient and cost-effective updating of firmware in an enterprise environment.

What is claimed is:

1. A method at an enterprise server for controlling installation of firmware updates at enterprise devices, the method comprising:
identifying a subset of the enterprise devices designated as alpha enterprise devices for testing functionality of firmware updates prior to installation of the firmware updates at the remaining enterprise devices designated as non-alpha enterprise devices, the alpha enterprise devices being configured to apply a first firmware update policy that enables firmware update installation; and
transmitting to each non-alpha enterprise device a first command to apply a second firmware update policy that disables or postpones firmware update installation.

2. The method of claim 1, wherein identifying a particular enterprise device designated as an alpha enterprise device comprises:
receiving an indication of the particular enterprise device to designate as the alpha enterprise device; and
storing, in a memory accessible to the enterprise server, an alpha designation in association with an identifier of the particular enterprise device.

3. The method of claim 2, wherein the indication is received in a transmission from the particular enterprise device.

4. The method of claim 2, wherein the indication is input locally at the enterprise server.

5. The method of claim 1, further comprising:
determining that a new firmware version has been installed at a number of alpha enterprise devices of a particular type; and
for a period of time, monitoring for problems associated with installation of the new firmware version at the alpha enterprise devices of the particular type.

6. The method of claim 5, further comprising:
responsive to determining that no problems associated with the installation have been identified during the period of time, transmitting to each non-alpha enterprise device of the particular type a second command to apply the first firmware update policy that enables firmware update installation.

7. The method of claim 6, further comprising:
responsive to determining that the new firmware version has been installed at a particular non-alpha enterprise device, transmitting to the particular non-alpha enterprise device a third command to apply the second firmware update policy that disables or postpones firmware update installation.

8. The method of claim 5, further comprising:
responsive to determining that one or more problems associated with the installation have been identified during the period of time, initiating a problem resolution process.

9. An enterprise server for controlling installation of firmware updates at enterprise devices, the enterprise server comprising:
a processor;
a communication interface configured for communication with the enterprise devices over a communication network; and
a memory storing code which, when executed by the processor, causes the enterprise server:
to identify a subset of the enterprise devices designated as alpha enterprise devices for testing functionality of firmware updates prior to installation of the firmware updates at the remaining enterprise devices designated as non-alpha enterprise devices, the alpha enterprise devices being configured to apply a first firmware update policy that enables firmware update installation; and
to transmit to each non-alpha enterprise device a first command to apply a second firmware update policy that disables or postpones firmware update installation.

10. The enterprise server of claim 9, wherein the code, when executed by the processor, further causes the enterprise server:
responsive to receiving an indication of a particular enterprise device to designate as an alpha enterprise device, to store an alpha designation in association with an identifier of the particular enterprise device.

11. The enterprise server of claim 10, wherein the enterprise server is configured to receive the indication via the communication interface in a transmission from the particular enterprise device.

12. The enterprise server of claim 10, further comprising:
an input device configured to receive the indication input locally at the enterprise server.

13. The enterprise server of claim 9, wherein the code, when executed by the processor, further causes the enterprise server:
to determine that a new firmware version has been installed at a number of alpha enterprise devices of a particular type; and
for a period of time, to monitor for problems associated with installation of the new firmware version at the alpha enterprise devices of the particular type.

14. The enterprise server of claim 13, wherein the code, when executed by the processor, further causes the enterprise server:
responsive to determining that no problems associated with the installation have been identified during the period of time, to transmit to each non-alpha enterprise device of the particular type a second command to apply the first firmware update policy that enables firmware update installation.

15. The enterprise server of claim 14, wherein the code, when executed by the processor, further causes the enterprise server:
responsive to determining that the new firmware version has been installed at a particular non-alpha enterprise device, to transmit to the particular non-alpha enterprise device a third command to apply the second firmware update policy that disables or postpones firmware update installation.

16. A non-transitory computer-readable memory storing code which, when executed by a processor of an enterprise server, causes the enterprise server:
to identify a subset of the enterprise devices designated as alpha enterprise devices for testing functionality of firmware updates prior to installation of the firmware updates at the remaining enterprise devices designated as non-alpha enterprise devices, the alpha enterprise devices being configured to apply a first firmware update policy that enables firmware update installation; and
to transmit to each non-alpha enterprise device a command to apply a second firmware update policy that disables or postpones firmware update installation.

17. The non-transitory computer-readable memory of claim 9, wherein the code, when executed by the processor, further causes the enterprise server:
responsive to receiving an indication of a particular enterprise device to designate as an alpha enterprise device, to store an alpha designation in association with an identifier of the particular enterprise device.

18. The non-transitory computer-readable memory of claim 16, wherein the code, when executed by the processor, further causes the enterprise server:
to determine that a new firmware version has been installed at a number of alpha enterprise devices of a particular type; and
for a period of time, to monitor for problems associated with installation of the new firmware version at the alpha enterprise devices of the particular type.

19. The non-transitory computer-readable memory of claim 18, wherein the code, when executed by the processor, further causes the enterprise server:
responsive to determining that no problems associated with the installation have been identified during the period of time, to transmit to each non-alpha enterprise device of the particular type a second command to apply the first firmware update policy that enables firmware update installation.

20. The non-transitory computer-readable memory of claim 19, wherein the code, when executed by the processor, further causes the enterprise server:
responsive to determining that the new firmware version has been installed at a particular non-alpha enterprise device, to transmit to the particular non-alpha enterprise device a third command to apply the second firmware update policy that disables or postpones firmware update installation.
